(19) United States
(12) Patent Application Publication
(10) Pub. No.: US 2004/0076216 A1
(43) Pub. Date: Apr. 22, 2004

(54) Thermographic system and method for detecting imperfections within a bond

(76) Inventors: Craig A. Chamberlain, St. Augustine, FL (US); Marvin E. Banks JR., Merritt Island, FL (US); Tim C. King, Geneva, FL (US)

Correspondence Address: Jeffrey J. Chapp, Artz & Artz, P.C., Suite 250, 28333 Telegraph Road, Southfield, MI, 48034, US

(21) Appl. No.: 10/274,273

(22) Filed: Oct. 18, 2002

(51) Int. Cl. G01N 19/08

(52) U.S. Cl. 374/57; 374/45

(57) ABSTRACT

A thermographic detection system (10) and method for detecting imperfections within a bond (23) of a structure (14′). The system (10) includes a cooling device (32) for nondestructively cooling a bonded region (24) of the structure (14′). A thermal sensor (34) detects thermal changes within the bonded region (24) and generates a thermal signal. A thermal indicator (36) is electrically coupled to the thermal sensor (34) and indicates the thermal changes in response to the thermal signal.

The invention described herein was made in the performance of work under NASA Contract No. NAS10-11400 and is subject to the provisions of Section 305 of the National Aeronautics and Space Act of 1958 (72 Stat.435:42U.S.C.2457).

### TECHNICAL FIELD

The present invention relates generally to nondestructive evaluation of thermal properties of bonds, and more particularly, to a system and method of detecting imperfections within a bond of a structure.

### BACKGROUND OF THE INVENTION

Infrared (IR) imaging has been used as a nondestructive testing technique in detection of defects and corrosion as well as detection of disbonding within a laminated structure. Throughout industry laminated structures are utilized for various applications. Imperfections and disbanding within a structure can adversely effect fidelity and operational life of the structure. Thermographic devices such as laser scanners, infrared cameras, thermocouples, and the like have been used in inspecting structures.

To some extent these thermographic devices have portability, expense, and adaptability advantages in field use as compared to other known methods. Many of these devices use full field noncontacting imaging and accordingly require a significant amount of equipment, rendering inspection limited to areas of easy access. Unfortunately, a large number of the test structures currently in use are located in somewhat inaccessible areas having geometry as such that it is impractical to attempt to generate a full field IR image.

One current method of detecting imperfections within a structure utilizes pulsed IR to heat the structure. After cooling of the structure, imperfection areas are identified as localized hot spots through use of an IR scanner, control electronics, and other analysis equipment. Another known method utilizes a laser to heat a focalized area of a structure and a probe to detect eddy currents within the structure. The eddy currents are indicative of flaws or holes in the structure. This method also utilizes various equipment including voltmeters, amplifiers, eddy scopes, recorders, and translators. The above-mentioned methods do not lend themselves to being portable due to the amount and size of the equipment involved. Both methods limit inspection to more of a lab-based environment, are costly to implement, and require a significant amount of data processing and analysis time.

Yet another imperfection detecting method known in the art uses a magnetic induction generator to remotely heat a region of a structure. A thermal sensor senses temperature changes in the heated region as a function of time. A computer compares the temperature changes with similar samples having known disbond and inclusion geographies to analyze the structure. This method although being more portable than previous methods is also limited, especially due the amount of prior structure data that is required and the amount of time involved in performing the comparison. Also, this method, as well as the other methods previously mentioned, requires use of a relatively expensive device in order to heat an area of a structure.

It is therefore desirable to provide a thermographic inspection system that is portable, relatively inexpensive to manufacture and implement, and that requires relatively a small amount of data processing time.

### SUMMARY OF THE INVENTION

The present invention provides a thermographic detection system and method of detecting imperfections within a bond of a structure. The system includes a cooling device for nondestructively cooling a bonded region of the structure. A thermal sensor detects thermal changes within the bonded region and generates a thermal signal. A thermal indicator is electrically coupled to the thermal sensor and indicates the thermal changes in response to the thermal signal.

The present invention has several advantages over existing thermographic evaluation systems. One advantage is that it provides an easy to implement, inexpensive, and portable, technique for detecting imperfections within a bond of a structure.

Another advantage of the present invention is that it provides real time detection of imperfections. By using the present invention, imperfections may be detected within several seconds upon cold shocking of a bonded region.

Furthermore, the present invention is versatile in that it may be applied in many vastly different and distinctive applications due to its simplicity and portability.

The present invention itself, together with further objects and attendant advantages, will be best understood by reference to the following detailed description, taken in conjunction with the accompanying drawing.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a space station having multiple bonded structures in accordance with an embodiment of the present invention;

FIG. 2 is a perspective view of a truss segment of the space station having multiple bonded structures in accordance with an embodiment of the present invention;

FIG. 3 is a perspective close-up view of a bonded structure in accordance with an embodiment of the present invention;

FIG. 4 is a block diagrammatic view of a thermographic detecting system in accordance with an embodiment of the present invention;

FIG. 5 is a cooling device including a vortex in accordance with an embodiment of the present invention;

FIG. 6 is a logic flow diagram illustrating a method of detecting imperfections within a bond of a structure in accordance with an embodiment of the present invention;

FIG. 7A is a thermal image of a bond, having a void, of a structure upon being cold shocked in accordance with an embodiment of the present invention;

FIG. 7B is a thermal image of the bond of FIG. 7A approximately five seconds after being cold shocked in accordance with an embodiment of the present invention; and

FIG. 7C, is a thermal image of the bond of FIG. 7A approximately ten seconds after being cold shocked in accordance with an embodiment of the present invention.

### DETAILED DESCRIPTION OF THE PREFERRED EMBODIMENT

In each of the following figures, the same reference numerals are used to refer to the same components. While the present invention is described with respect to a system and method of detecting imperfections within a bond of a structure, the present invention may be adapted for various applications including automotive, marine, aerospace, and other applications known in the art. The present invention may be applied within multiple industries including residential and commercial building, industrial and household furnishings, electronic, apparel, sporting goods, textile, packaging, and other industries. The present invention may also be applied to various adhesives, laminates, and bonds and also to various materials including tire structures, carpeting, decals, Velcro®, carbon fiber, composites, metallic components, glued seams, etc. The present invention may be applied during manufacturing of a device or during operational use of the device.

In the following description, various operating parameters and components are described for one constructed embodiment. These specific parameters and components are included as examples and are not meant to be limiting.

Also, in the following description the terms “bonded structure”, “bonded region”, and “a bond of a structure” refer may refer to any bonded, adhesive, or attached area of a structure. A bond may be any type of coupling or attachment between to devices, components, or objects.

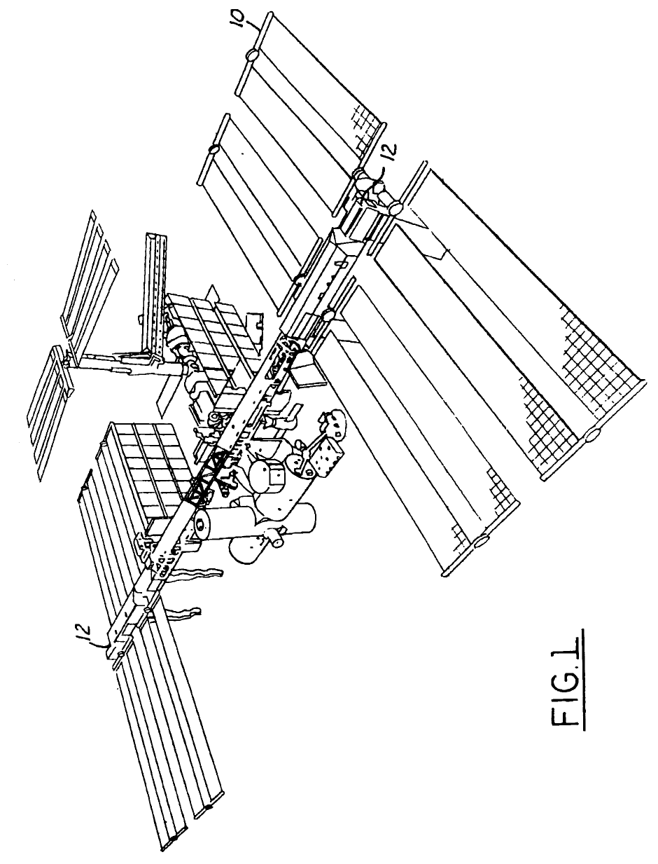

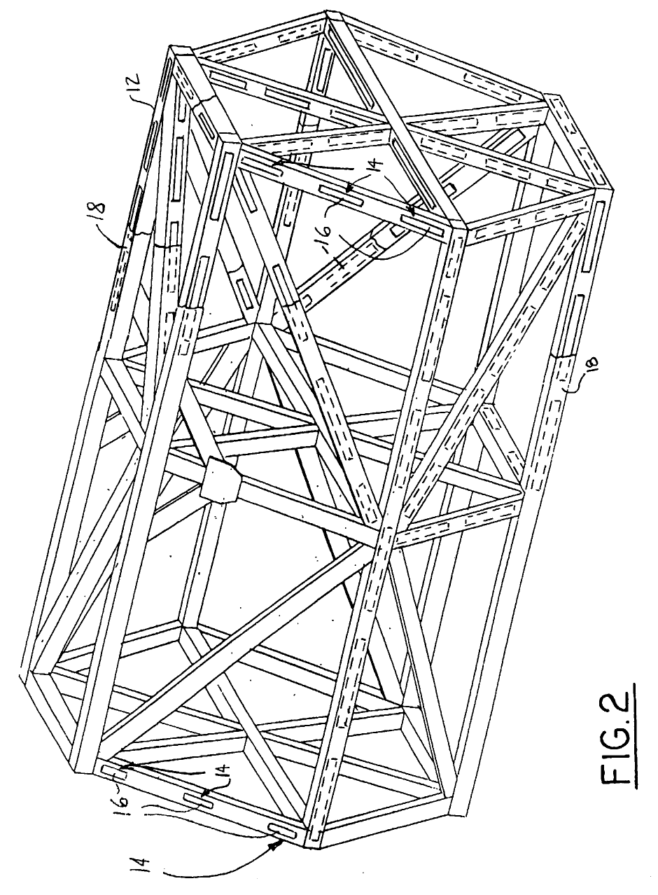

Referring now to FIGS. 1 and 2, perspective views of a space station 10 and a truss segment 12 of the space station 10 each having multiple bonded structures 14 in accordance with an embodiment of the present invention is shown. The space station 10 is shown as one possible example of an application for the present invention. The space station 10 has multiple truss segments 12 each of which having multiple Velcro® strips 16 for attachment of a protective cover 18 to the truss segments 12 to form the bonded structures 14.

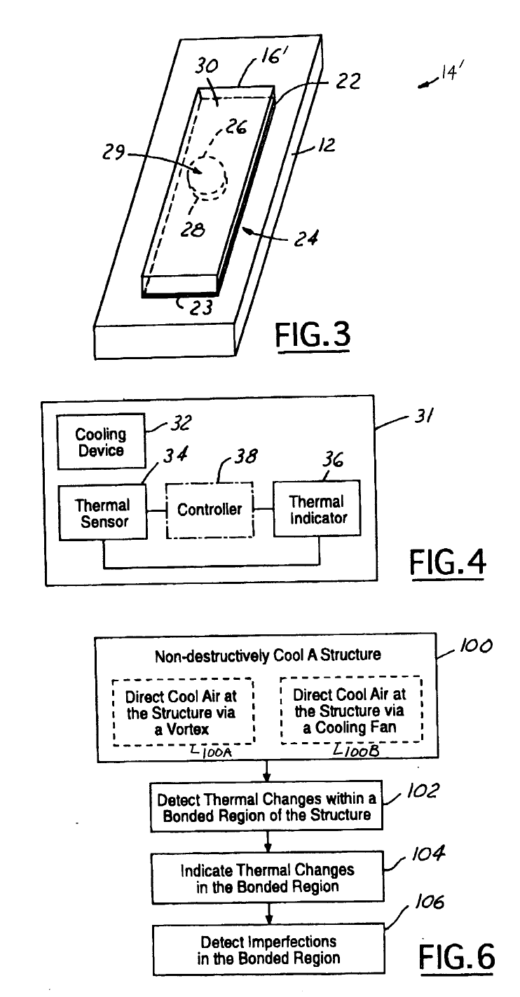

Referring now to FIG. 3, a perspective close-up view of a bonded structure 14′ in accordance with an embodiment of the present invention is shown. A Velcro® strip 16′ is adhesively bonded to the segment 12 via a high strength epoxy layer 22, forming a bond 23 having a bonded region 24. The bonded region 24 may contain one or more imperfections 26, such as voids, cracks, or air pockets; a single void 28 having a corresponding area 29 is shown. Numerical designator 30 denotes the remaining portion of the region 24 that does not include the void 28. The imperfections 26 may exist during manufacturing, for example due to poor lamination, or may be formed during operational life of the structure 14′.

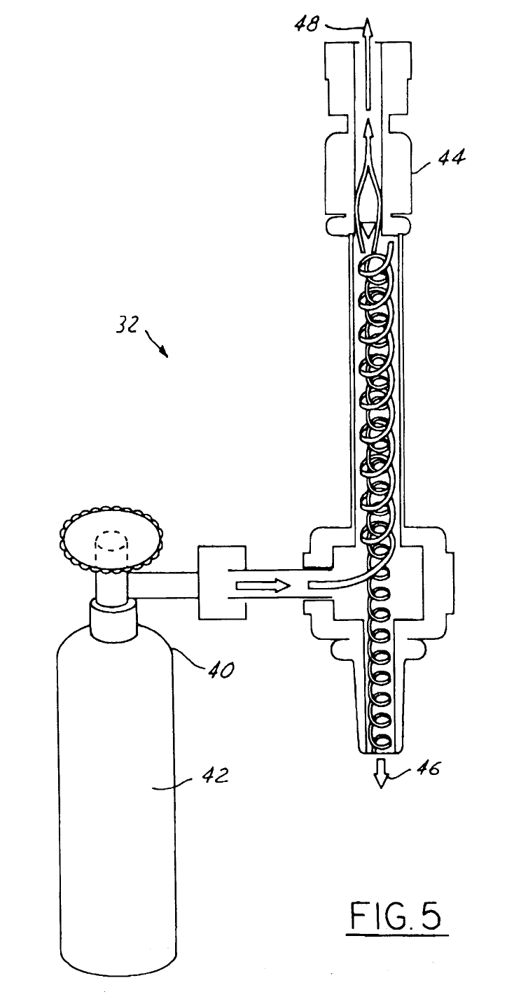

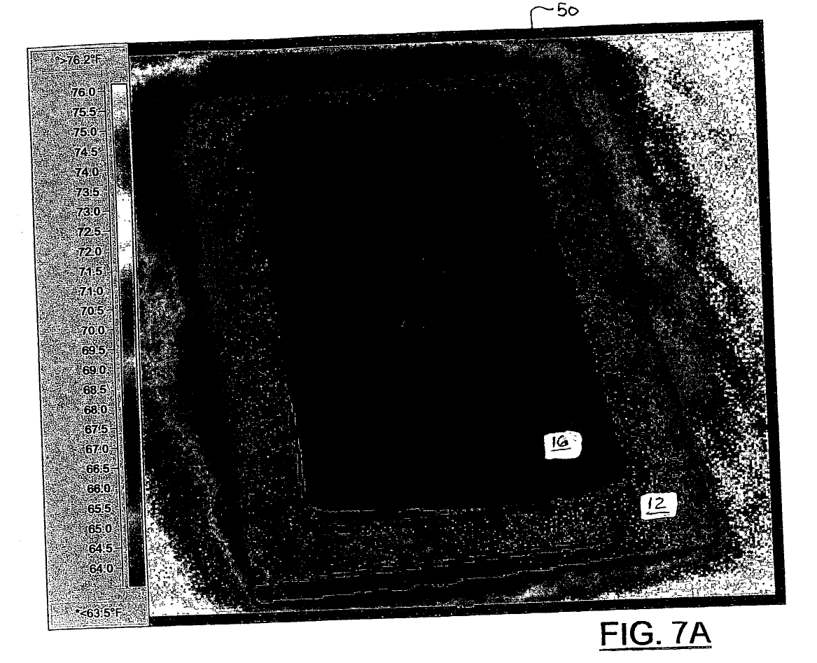

Referring now to FIG. 4, a block diagrammatic view of a thermographic detecting system 31 in accordance with an embodiment of the present invention is shown. The system 31 includes a cooling device 32 for thermal cooling or cold shocking the region 24. A thermal sensor 34 detects thermal changes within the region 24. A thermal indicator 36 is electrically coupled to the thermal sensor 34 and indicates the thermal changes. A controller 38 may be electrically coupled to the thermal sensor 34 and the thermal indicator 36 and compare the thermal changes to predetermined thermal changes for the region 24 to detect imperfections.

The cooling device 32 may be of various types and styles as known in the art for cooling an object. In one embodiment of the present invention the cooling device 32 includes a container or holding device 40 having a cooling fluid 42 contained therein. The cooling fluid 42 may be compressed air, a refrigerant gas or an inert gas such as tetrafluoroethane, or some other cooling fluid 42 as known in the art. For example, in another embodiment of the present invention a cooling can or dust can containing tetrafluoroethane is used to cool a structure, as further described in step 100B below. A vortex 44 may be utilized in releasing relatively cold air 46 as to cool the region 24. The vortex 44 is coupled to the holding device 40 and, as known in the art, separates compressed air into warm air 48 and the cold air 46. A cooling device using a cooling fluid, such as compressed air, that exhibits low contamination and has a safe hazardous use rating is preferred to prevent adverse effects to objects within a treated area and to provide ease and safe implementation.

The thermal sensor 34 may be a thermal imager, a thermal camera, a laser scanner, a thermal couple, a thermographer, a thermistor, a thermo-switch, a thermal resistor, a thermo-diode, a thermometer, a fiber-optic sensor, or other thermal sensor known in the art or a portion thereof.

The thermal indicator 36 may be a thermal imager, a thermal camera, a laser scanner, a thermal strip, a liquid crystal indicator, a thermometer, a thermal display, or other thermal indicator known in the art or a portion thereof. The thermal sensor 34 and the thermal indicator 36 may be part of a single device, such as a thermal imager, which is preferably used due to its simplicity, portability, and real time imaging capability.

The controller 38 is preferably microprocessor based such as a computer having a central processing unit, memory (RAM and/or ROM), and associated input and output buses. The controller 38 may be a portion of a central main control unit, thermal imager, or may be a stand-alone controller as shown.

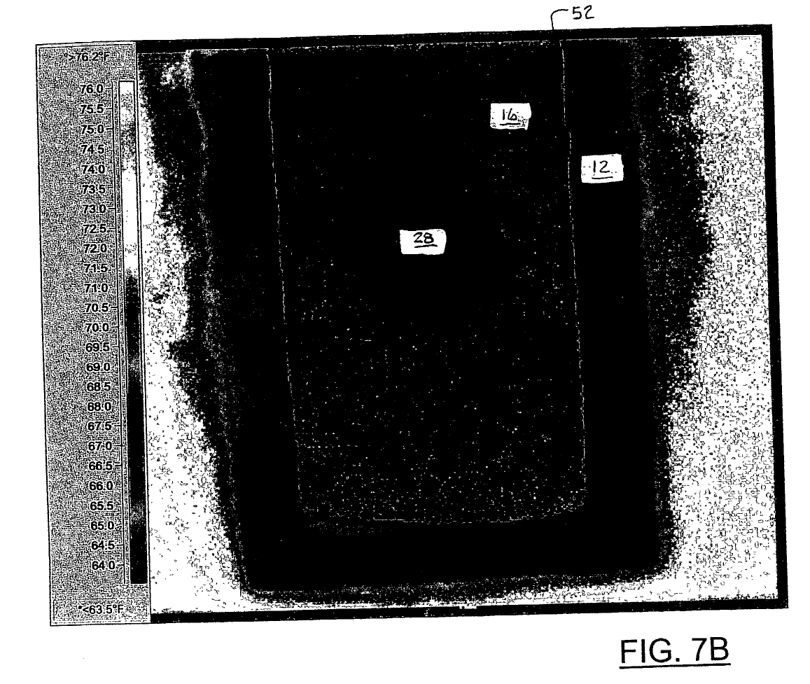

Referring now to FIG. 6, a logic flow diagram illustrating a method of detecting imperfections within a bond of a structure in accordance with an embodiment of the present invention is shown. The structure 14′ of FIG. 3 is used to illustrate and describe the following method.

In step 100, the cooling device 32 nondestructively cools the region 24. In step 100A, cooled air 46 is released and directed at the region 24 via the vortex 44. In step 100B, for smaller structures, a cooling can may be tipped upside down to release fluid within said cooling can at a relatively cold temperature. The cooling can may contain a refrigerant, an inert gas such as tetraflouroethane, or other cooling fluid known in the art. The region 24 in the example as illustrated was cold shocked to a temperature approximately between 15-20° below ambient temperature. Of course, depending upon the application various amounts of cooling or levels of being cold shocked may be preformed, in order to distinguish imperfections from other areas of a structure.

In step 102, the thermal sensor 34 detects thermal changes within the region 24 and generates a thermal signal. The thermal changes are detected after cooling of the region 24 as the structure 14′ is returning to a normal temperature state such as ambient temperature.

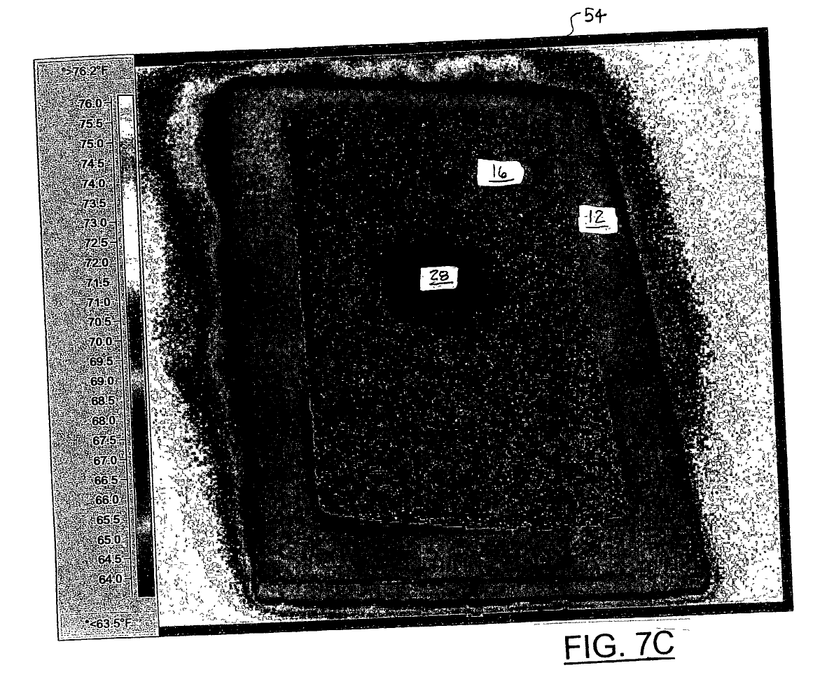

In step 104, the thermal indicator 36 indicates thermal changes in the region 24 in response to the thermal signal. As the structure 14′ is returning to the normal temperature state multiple thermal images are acquired for monitoring the thermal changes and detection of the void 28, as best seen in FIGS. 7A-7C. The acquired thermal images may be viewed in real time by the thermal indicator 36. FIGS. 7A-7C include thermal images 50, 52, and 54 of the structure 14′ upon being cold shocked, five seconds after being cold shocked, and ten seconds after being cold shocked, respectively.

In step 106, imperfections are detected in the region 24 in response to the thermal images 50-54. As the structure 14′ returns to ambient temperature a portion of the segment 12, corresponding to the area 29, remains at a colder temperature relative to the remaining portion 30, as can be seen and is denoted by the temperature color spectrum in FIGS. 7A-7C. The area 29 remains at a colder temperature for a longer period of time than does the remaining portion 30 since the segment 12, in the area 29, is not insulated by the strip 16′, as it is for the portion 30. A system operator viewing the thermal changes can quickly detect imperfections by noticing colder temperature areas in the bond 23.

The controller 38 may perform a comparison between the thermal images 50-54 and predetermined thermal images or predetermined thermal values to detect an imperfection in the structure 14′. The controller 38 in performing a comparison may use a first image, such as the image 50, as a reference and compare other images to the first image 50. Imperfections may be detected when portions of the region 24 are not changing in a consistent or uniform maimer. For example, as the region 24 returns to ambient temperature the void 28 does not change in temperature as rapidly over time as does the portion 30, thus the void 28 may be detected during initial moments of returning to ambient temperature, using methods known in the art. As differences in the region 24 are detected the controller 38 generates a difference signal, which may be indicated to a system operator, via the thermal indicator 36.

The above-described steps in the above methods are meant to be an illustrative example, the steps may be performed sequentially, synchronously, continuously, or in a different order depending upon the application.

The present invention provides a thermographic system of detecting imperfections within a bonded region of a structure that is portable, simple to use, relatively inexpensive, and provides real time response for quick efficient imperfection determination. The present invention is not lab-based intensive and requires only a minimal amount of equipment to implement.

The above-described apparatus and method, to one skilled in the art, is capable of being adapted for various applications and systems known in the art. The above-described invention can also be varied without deviating from the true scope of the invention.

What is claimed is:

1. A thermographic detection system for detecting imperfections within a bond of a structure comprising:
a cooling device for nondestructively cooling at least a portion of a bonded region of the structure;
at least one thermal sensor detecting thermal changes within at least a portion of said bonded region and generating a thermal signal; and
a thermal indicator electrically coupled to said at least one thermal sensor and indicating said thermal changes in response to said thermal signal.

2. A system as in claim 1 further comprising a controller electrically coupled to said at least one thermal sensor and said at least one thermal indicator and comparing said thermal changes with predetermined thermal changes to detect an imperfection in the structure.

3. A system as in claim 1 wherein said cooling device comprises a container having a cooling fluid.

4. A system as in claim 1 wherein said cooling device comprises:
a compressed air holding device having compressed air; and
a vortex coupled to said compressed air holding device and releasing relatively cold air.

5. A system as in claim 1 wherein said cooling device is a cooling can containing a cooling fluid.

6. A system as in claim 5 wherein said cooling fluid comprises a refrigerant gas.

7. A system as in claim 5 wherein said cooling fluid comprises an inert gas.

8. A system as in claim 1 wherein said at least one thermal sensor is selected from at least one of a thermal imager, a thermal camera, a laser scanner, a thermal couple, a thermographer, a thermistor, a thermo-switch, a thermal resistor, a thermo-diode, a thermometer, and a fiber-optic sensor.

9. A system as in claim 1 wherein said thermal indicator is selected from at least one of a thermal imager, a thermal camera, a laser scanner, a thermal strip, a liquid crystal indicator, a thermometer, and a thermal display.

10. A method of detecting imperfections within a bond of a structure comprising:
nondestructively cooling the structure;
detecting thermal changes within at least a portion of a bonded region of the structure and generating a thermal signal;
indicating thermal changes in at least a portion of said bonded region in response to said thermal signal; and
detecting at least one imperfection in the bonded region in response to said indicated thermal changes.

11. A method as in claim 10 wherein detection of said at least one imperfection occurs after cooling of the structure.

12. A method as in claim 10 wherein detection of said at least one imperfection occurs as the structure is returning to a temperature associated with a normal temperature state.

13. A method as in claim 10 wherein detection of said at least one imperfection occurs as the structure is returning to ambient temperature.

14. A method as in claim 10 further comprising comparing said thermal changes with predetermined thermal changes to detect an imperfection in the structure.

15. A method as in claim 10 wherein nondestructively cooling the structure comprises releasing cooled air via a vortex.

16. A method as in claim 10 wherein nondestructively cooling the structure comprises tipping a cooling can upside down to release fluid within said cooling can at a relatively cold temperature.

17. A method as in claim 10 wherein nondestructively cooling the structure comprises directing a cooling fluid as to cool at least a portion of said bonded region.

18. A method as in claim 10 further comprising:
generating a plurality of infrared images after cooling of the structure;
designating a first image as a reference image;
comparing subsequent images to said first image and generating a difference signal; and
detecting an imperfection in response to said difference signal.

19. A thermographic detection system for detecting imperfections within a bond of a structure comprising:
a cooling device for nondestructively cooling at least a portion of a bonded region of the structure comprising;
a compressed air holding device having compressed air; and
a vortex coupled to said compressed air holding device and releasing cooled air;
at least one thermal sensor detecting thermal changes within at least a portion of said bonded region and generating a thermal signal; and
a thermal indicator electrically coupled to said at least one thermal sensor and indicating said thermal changes in response to said thermal signal.

20. A system as in claim 19 further comprising a controller electrically coupled to said at least one thermal sensor and said at least one thermal indicator and comparing said thermal changes with predetermined thermal changes to detect an imperfection in the structure.
